(19) United States
(12) Patent Application Publication
(10) Pub. No.: US 2007/0290887 A1
(43) Pub. Date: Dec. 20, 2007

(54) Portable traffic signal

(76) Inventor: Loran Irvin Pleasanton, Boynton Beach, FL (US)

Correspondence Address: Loran Pleasanton, 235 SW 13th Ave, Boynton Beach, FL, 33435, US

(21) Appl. No.: 11/764,848

(22) Filed: Jun. 19, 2007

Related U.S. Application Data
(60) Provisional application No. 60/814,933, filed on Jun. 19, 2006.

(51) Int. Cl. G08G 1/095

(52) U.S. Cl. 340/908

(57) ABSTRACT

A portable traffic signal for controlling traffic through an intersection includes a base for surrounding and capturing a pylon. The pylon has a lower portion that is mechanically coupled to the base and an upper portion that is mechanically coupled to a signal head. A primary power source is positioned within the pylon, and provides power to operate the signal head. The portable traffic signal is large, lightweight and can be assembled at an intersection by a single person.

### CROSS REFERENCE TO RELATED APPLICATIONS

This application is based on provisional patent application Ser. No. 60/814,933 entitled “Portable Traffic Signal for Intersections” by Loran Irvin Pleasanton, filed Jun. 19, 2006, which is incorporated by reference herein.

### BACKGROUND OF THE INVENTION

This present invention relates generally to the field of traffic signals and more specifically to a portable traffic signal that can simultaneously control up to four directions of conflicting vehicular right-of-ways through an intersection.

After Hurricane Wilma hit South Florida in October of 2005, many intersections had traffic lights that were destroyed. Motorists were told to treat intersections with 24 approach lanes as four way stops. This solution did not work well. There were many accidents. During peak travel periods four officers were required to direct traffic at each major intersection. There were not enough officers to staff all major intersections. Repair of the lights took months due to a lack of replacement lights and manpower to install them.

Portable traffic signals have existed in one form or another for many years as represented by U.S. Pat. Nos. 4,543,905, 4,992,788, 5,986,576, and design Pat. No. D457,827S.

U.S. Pat. No. 4,543,905, entitled “Portable traffic signaling apparatus and methods therefor”, issued Oct. 1, 1985 to John D. McKenney describes a portable traffic signaling apparatus of the wheeled trailer type for temporary signaling at a traffic location for controlling the flow of traffic thereat. The apparatus includes a telescoping mast and a telescoping boom carried by the trailer for positioning at the traffic location. The telescoping action is performed without any large bending loads to permit the extended boom carrying a traffic signal to be moved over a traffic lane under traffic conditions after the traffic apparatus is erected alongside of the traffic location. The extended mast may also carry a traffic signal to be viewed by motorists along with the boom suspended traffic signal. The mast and boom can be telescopically collapsed to assume a storage position on the wheeled trailer after the need for traffic control has been eliminated to allow the trailer to be hauled to another location.

U.S. Pat. No. 4,992,788, entitled “Traffic control trailer system”, issued Feb. 12, 1991 to Rudolph P. Arndt describes a portable traffic control system for control of traffic at temporary locations includes a trailer having a base supported by an axle and wheels, two signal supports connected to the base and an actuating mechanism for selectively urging the signal supports from a transporting position to an operating position and back. A transverse arm connected to one signal support is extendable laterally and outwardly from the trailer. A signal head is attached to the transverse arm and a second signal head is attached to the upper end of the second signal support.

U.S. Pat. No. 5,986,576, entitled “Remote control portable traffic control device and system”, issued Nov. 16, 1999 to Sheldyn Kyle Armstrong describes a remote control portable traffic signaling device and system for controlling a flow of traffic. The remote control portable traffic signaling system includes the portable signaling device and a plurality of warning flashers. The portable signaling device includes a remote control unit and a signal head having an LED display device and a microprocessor. The remote control unit transmits a control signal to be received by the microprocessor for use in controlling a message communicated by the LED display device. A base unit including a storage compartment for housing the power source is connected to the signal head for supplying power to the microprocessor and LED display device via a connection wire extending through a pole positioned therebetween. A device for adjustably connecting the pole between the signal head and base unit allows for height adjustment of the portable signaling device. A plurality of warning flashers including a pair of high luminous LEDs are positioned at a predetermined distance from the portable signaling device to warn passersby of the presence of the portable signaling device.

U.S. Design Pat. No. D457,827, entitled “Portable temporary traffic signal”, issued May 28, 2002 to Williams, et. al. illustrates a four face, three lamp, signal head mounted on a small diameter pole with a circular flat base plate.

Clearly, a better solution is needed for emergency traffic light service. A portable traffic signal that can be quickly deployed by public safety employees to replace damaged signals is needed. Features of such a portable traffic signal would include:

a single unit four face traffic signal

placeable quickly in the middle of an intersection

providing four coordinated and simultaneous directions of traffic control

large enough to be easily seen

designed to minimize risk to motorists who collide with the signal

remain in position after placement in winds of up to 40 Mph

function unattended for 10-14 days

Such a portable traffic signal as described above could quickly replace non-functioning signals of a traffic intersection after a natural or man made disaster, extended power outage, or accident. The portable traffic signal should be large, sturdy, and lightweight and have a highly visible signal lamp support structure. The portable traffic signal should provide a substantial profile to oncoming motorist making the signal easy to see and encouraging motorists to avoid collision with the signal, and when deployed in the center of an intersection would provide reasonable safety to motorists in the event of a vehicle collision with the signal.

### SUMMARY OF THE INVENTION

One object of the present invention is to provide a portable traffic signal that can be deployed by one person of average size and strength from a pick up truck in less than 10 minutes.

Another object of the present invention is to provide a portable traffic signal with enhanced low light visibility.

Another object of the present invention is to provide a portable traffic signal that assembles at the intersection without any fasteners. The portable traffic signal members would be assembled using slip, snap, or twist lock features, or are secured by other techniques without fasteners.

A further object of the present invention is to provide a portable traffic signal that has provision for at least one power source storage in the vertical member of the signal device.

Another object of the present invention is to provide a portable traffic signal controller that is simple to use.

Yet another object of the present invention is to provide a portable traffic signal that efficiently uses available system power to extend maintenance/service intervals.

Still another object of the present invention is to provide a portable traffic signal that has provisions for detecting an impact or knock over situation.

Another object of the present invention is to provide a portable traffic signal that has the ability to call for assistance via a cellular modem.

Another object of the present invention is to provide a portable traffic signal that has provisions for detecting the condition of the primary and conflict monitor power sources.

A further object of the present invention is to provide a portable traffic signal that is blue tooth enabled for local on site control of the signal via a remote device (lap top computer, PDA, cell phone or other blue tooth enabled device).

Yet another object of the present invention is to provide a portable traffic signal that is capable of reporting the condition of power sources when necessary via the cellular or Blue Tooth link.

A further object of the present invention is to provide a portable traffic signal that is capable of reporting a traffic signal identification code via a cellular modem, blue tooth link, or RF receiver transmitter.

Another object of the present invention is to provide a portable traffic signal that is capable of requesting service when a conflict condition is detected by the conflict monitor via a cellular modem link.

Another object of the present invention is to provide a portable traffic signal that is able to report it's location via a cellular modem link.

A further object of the present invention is to provide a portable traffic signal that is able to take instructions/commands via a cellular modem link.

Other objects and advantages of the present invention will become apparent from the following descriptions, taken in connection with the accompanying drawings, wherein, by way of illustration and example, an embodiment of the present invention is disclosed.

### BRIEF DESCRIPTION OF THE DRAWINGS

The drawings constitute a part of this specification and include exemplary embodiments to the present invention, which may be embodied in various forms. It is to be understood that in some instances various aspects of the present invention may be shown exaggerated or enlarged to facilitate an understanding of the present invention.

FIG. 1 is a perspective view of a portable traffic signal in accordance with the present invention.

FIG. 2 is a perspective view of a handheld controller in accordance with the present invention.

FIG. 3 is an elevational view of the portable traffic signal in accordance with the present invention.

FIG. 4 is an exploded view of a pylon assembly in accordance with the present invention.

FIG. 5 is an exploded view of a support base assembly in accordance with the present invention.

FIG. 6 is a sectional view of the signal head assembly in accordance with the present invention.

FIG. 7 is a top view of a signal head assembly in accordance with the present invention.

FIG. 8 is an elevational view of the signal head assembly showing a location for a controller.

FIG. 9 is a perspective view of the pylon assembly showing the position of primary power sources in accordance with the present invention.

FIG. 10 is a sectional view of the base assembly showing the position of optional sand bags.

FIG. 11 is a perspective view of a signal housing.

FIG. 12 is a perspective view of the portable traffic signal being deployed in accordance with the present invention.

FIG. 13 is a schematic block diagram of the controller, conflict monitor and associated electronics in accordance with the present invention.

It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner. In the drawings, similar reference characters denote similar elements throughout the several views

### DETAILED DESCRIPTION OF THE PREFERRED EMBODIMENTS

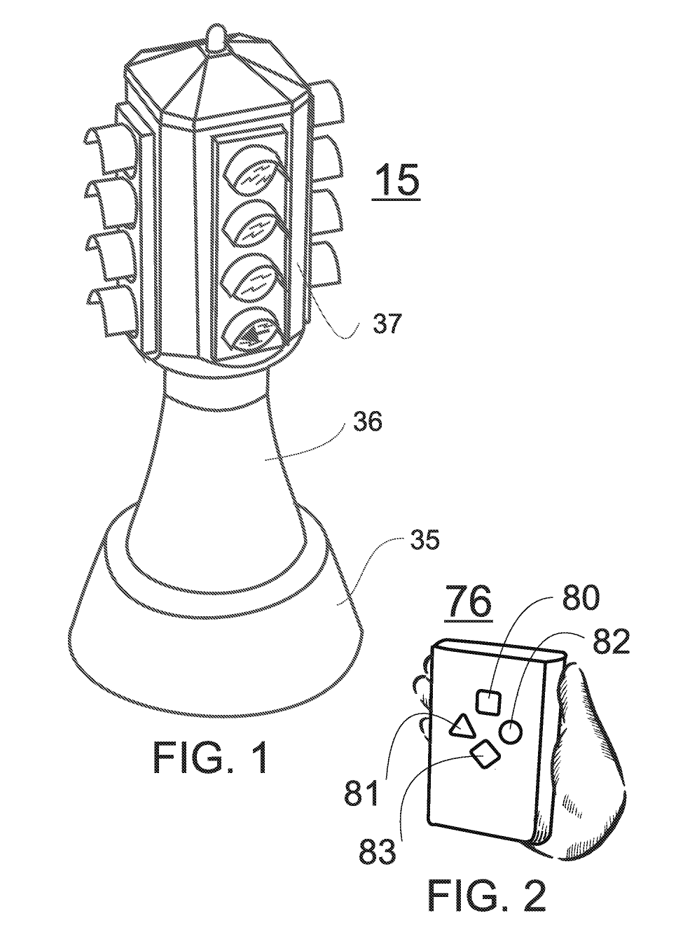

Referring to FIG. 1, a perspective view of a portable traffic signal 15 in accordance with the present invention is shown. The portable traffic signal 15 includes a signal head assembly 37, herein after referred to as signal head 37, that is mechanically connected to a pylon assembly 36, herein after referred to as pylon 36, which is further mechanically connected to a base assembly 35, herein after referred to as base 35.

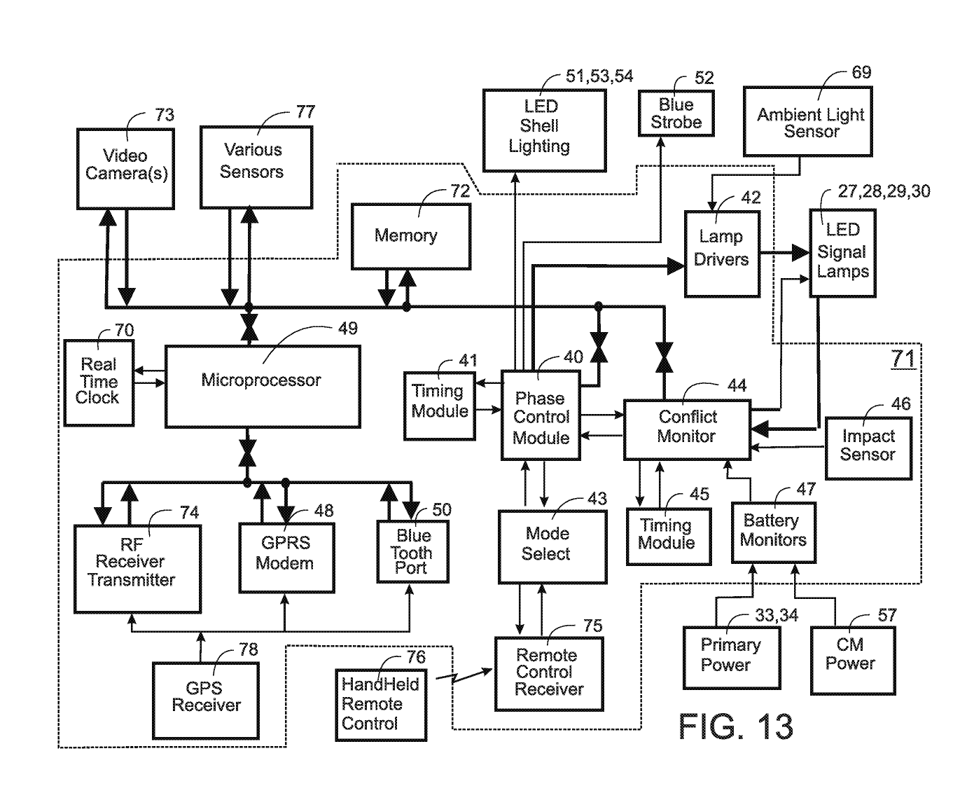

Referring to FIG. 2, there is shown a perspective view of a handheld controller 76 in accordance with the present invention. The handheld controller 76 is an off the shelf generic controller. Button 81 on hand held controller 76 is configured to scroll through the available features of LED controller 71 shown and described in FIG. 13 below. Button 82 on the handheld controller 76 is configured to scroll through the various options of each feature. Button 80 on the handheld controller 76 is configured as a select button for features and options. Button 83 on the handheld controller 76 is configured as a Start/Sequence function. A description of the operation of the handheld controller 76 is provided below in FIG. 13.

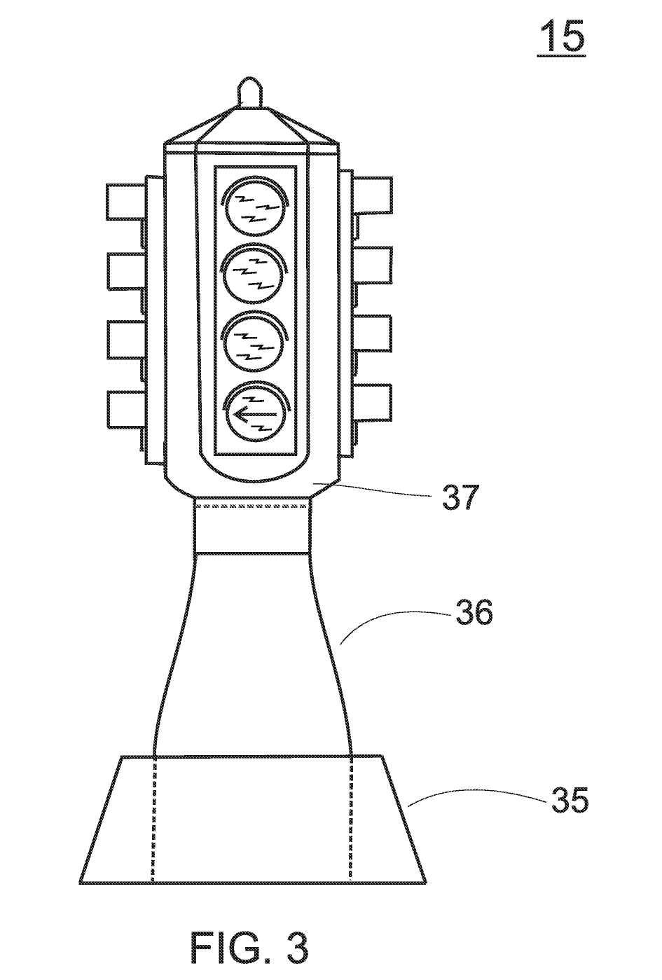

FIG. 3 depicts an elevational view of a fully assembled portable traffic signal 15. The base 35 is positioned on the ground at the center of an intersection. The pylon 36 is then slipped into the base 35. The signal head 37 is next slipped over the top of the pylon 36 and connected to a power source via wiring typical of the industry, and well known to one of ordinary skill in the art, as will be described below.

As described above, the preferred method of on-site assembly for the portable traffic signal 15 incorporates parts that slip together without additional fasteners such as pop rivets, screws, bolts or pins. It will be apparent to some one of ordinary skill in the art that many other assembly techniques are possible, such as, but not limited to, the use of twist locking features, snaps, or other integral engagement and release features common to the industry and well known to one of ordinary skill in the art. Engagement features may vary depending on the choice of material and the fabrication technique chosen.

There are many manufacturing processes and materials available for implementation of the primary mechanical components of the portable traffic signal 15; the base 35, the pylon 36, and the signal head 37 as described above. A composite glass and polyester resin (fiberglass) or graphite and polyester (or epoxy) resin is preferred for low volume production and to produce the most durable parts. However, parts can also be made from various plastics including, but not limited to, UV protected polycarbonate, polystyrene, high density polypropylene and many other materials common to the industry using readily available manufacturing processes such as, but not limited to, thermoforming, vacuum forming, pressure forming, twin sheet forming, and blow molding.

Although the preferred shape is shown in the attached figures it will be apparent to one of ordinary skill in the art that alternate shapes for the base assembly 35, pylon 36 and signal head 37 are also possible.

The color of the base 35, the pylon 36 and the signal head 37 are preferably Omaha orange, Federal Standard 595-B Number 12243 or construction/maintenance orange in accordance with MUTCD color requirements. Alternately, the color School Bus Yellow can be used for the base 35, the pylon 36, and the signal head 37.

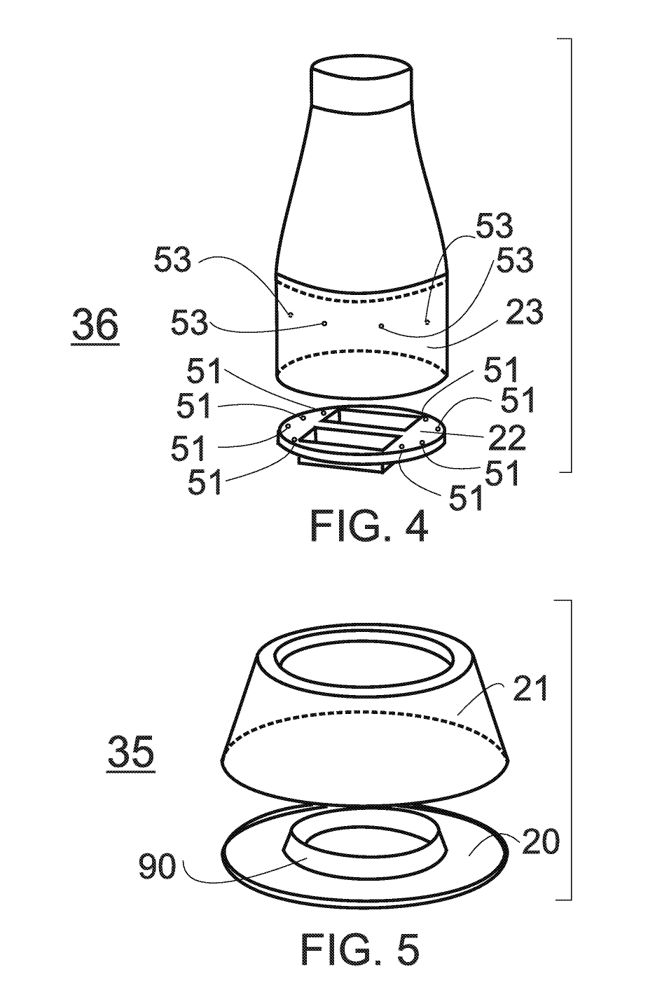

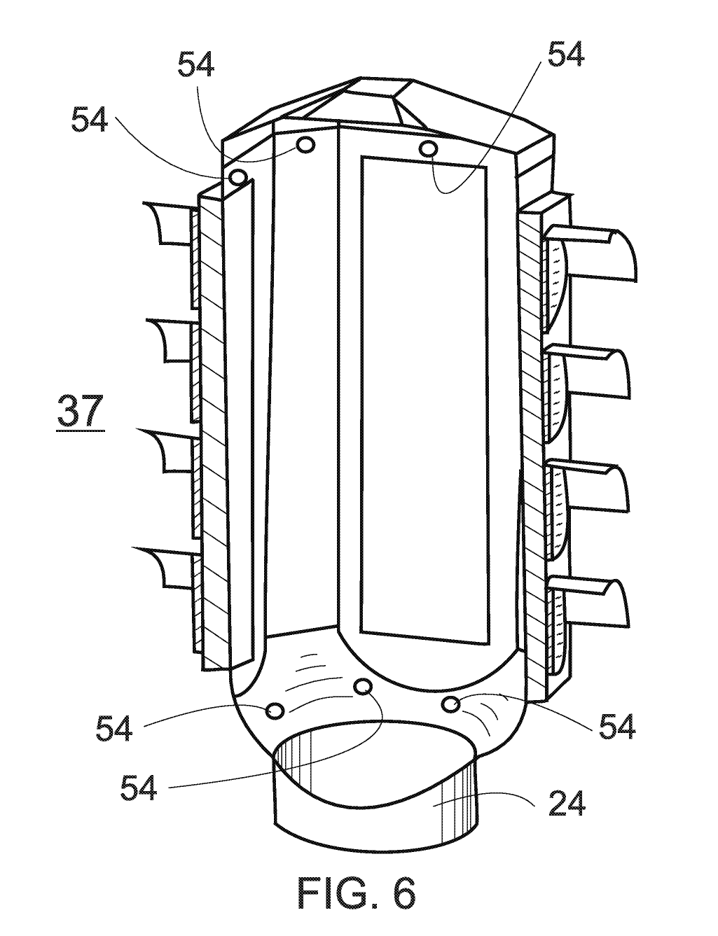

Additionally, the base 35, the pylon 36, and the signal head 37 can be impregnated with a phosphorescent material or coated with a phosphorescent material to improve low light visibility. The phosphorescent materials can be used separately or in conjunction with pylon shell lighting LEDs 51, base shell lighting LEDs 53 and signal head lighting LEDs 54 as will be described below in FIG. 4 and FIG. 6 respectively

Referring to FIG. 4, an exploded view of the pylon 36 is shown in accordance with the present invention. The pylon 36 is a large sturdy yet lightweight support structure for supporting the signal head 37 as described above. The pylon 36 includes a pylon shell 23 and a battery deck 22. As depicted in FIG. 4, the pylon 36 can include a plurality of shell lighting LEDs 51 distributed around the interior surface of the battery deck 22 in such a manner that when the pylon shell 23 is made from a translucent material, the exterior of the pylon 36 appears to glow when illuminated from the inside at night. In addition, the pylon shell 23 can have a plurality of shell lighting LEDs 53 positioned around the exterior surface below the battery deck 22, in such a manner when the base shell 21, as shown in FIG. 5, is made from a translucent material, the exterior of the base 35 appears to glow when illuminated from the inside at night in a similar manner as the pylon 36. It should be noted that any number and type of LEDs and LED arrangements can be used for this purpose and the design is not limited to that shown in FIG. 4. LEDs 51 and LEDs 53 are preferably ultra bright white LEDs, but other color LEDs can be utilized as well.

Referring to FIG. 5, the base 35 is shown an exploded view of the base 35 in accordance with the present invention. The base 35 is a large sturdy yet lightweight structure that includes a base plate 20 that is attached to a base shell 21, such as via aluminum pop rivets or other techniques common to the industry and well known to one of ordinary skill in the art. The base plate 20 has a concentric alignment feature 90 that serve to center and capture the bottom of pylon 36 when installed into the base 35. Additionally the base shell 21 surrounds and braces the pylon 36 in a vertical position. The concentric alignment feature 90 in the base plate 20 also serves as a locating feature for optional sand bag(s) as shown and described in FIG. 10 below.

Referring to FIG. 6, a cross-sectional view of the signal head 37 in accordance with the present invention is shown. A plurality of shell lighting LEDs 54 can be arranged internal to the signal head shell 24. Shell lighting LEDs 54 when illuminated at night cause the signal head shell 24 to glow softly improving signal visibility. It should be noted that any number and type of LEDs and LED arrangements can be used for this purpose and the design is not limited to that shown in FIG. 6. LEDs 54 are preferably ultra bright white LEDs, but other color LEDs can be utilized as well

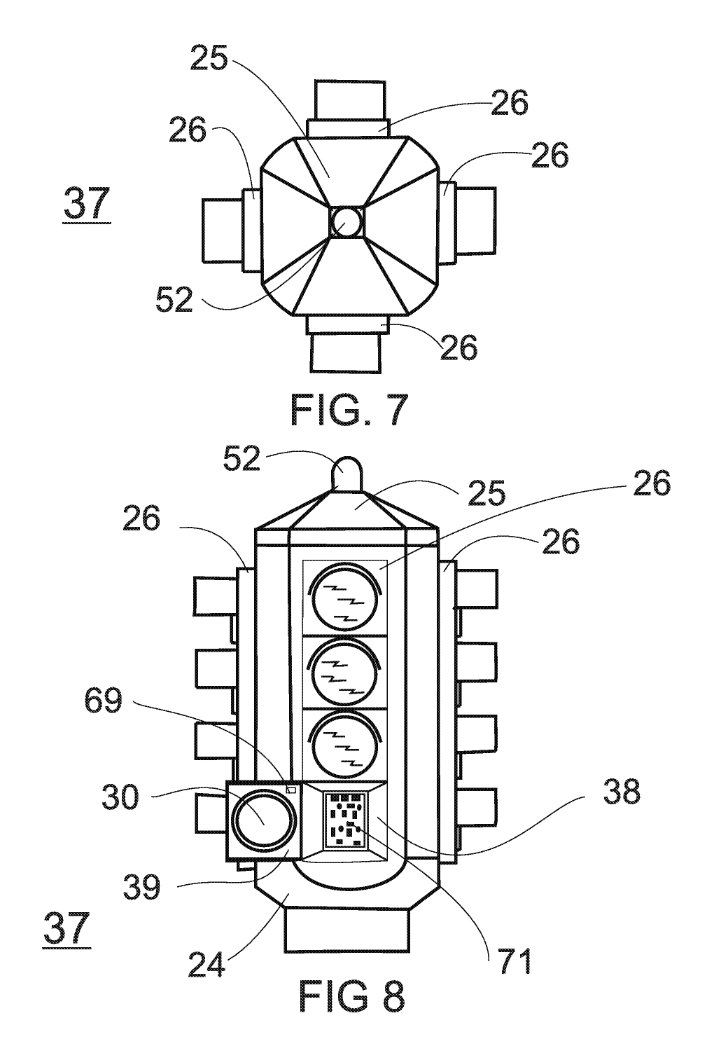

FIG. 7 is a top view of the signal head 37 in accordance with the present invention showing the placement of four signal housings 26, one signal housing 26 on each vertical face of the signal head 37. A blue strobe 52 is located in the center of a signal head cap 25, the function of which will be described below.

FIG. 8 is an elevation view of signal head 37 in accordance with the present invention. Four signal housings 26 are assembled to the signal head shell 24 of signal head 37 as discussed above in FIG. 7. The signal head cap 25 is attached to the top of the signal head 37 such as via aluminum pop rivets or other techniques common to the industry and well known to one of ordinary skill in the art and provides weather protection as well as a place to mount the blue strobe 52. Further, FIG. 8 depicts the industry standard signal housing 26 with signal housing door 39 open and with the backside of a LED lamp 30 visible. An ambient light sensor 69 is shown attached to the inside of the signal housing door 39 and is used to sense ambient light levels. A 12 Vdc low power controller and conflict monitor 71, herein after referred to as controller 71 is positioned behind door 39 in a cavity 38 of the signal housing 26. The controller 71 is connected to the other three signal housings through wiring typical to the industry in a manner well known to one of ordinary skill in the art. Other than the fact that the controller 71 and mounting provisions have been added only to one signal housing 26, it is otherwise identical to the other three signal housings. In the alternate, the controller could be positioned behind any of the LED lamps or in any signal housing with the proper provisioning. Alternately, when provision is made, the signal controller 71 can be placed inside the signal head 37 or within the pylon 36.

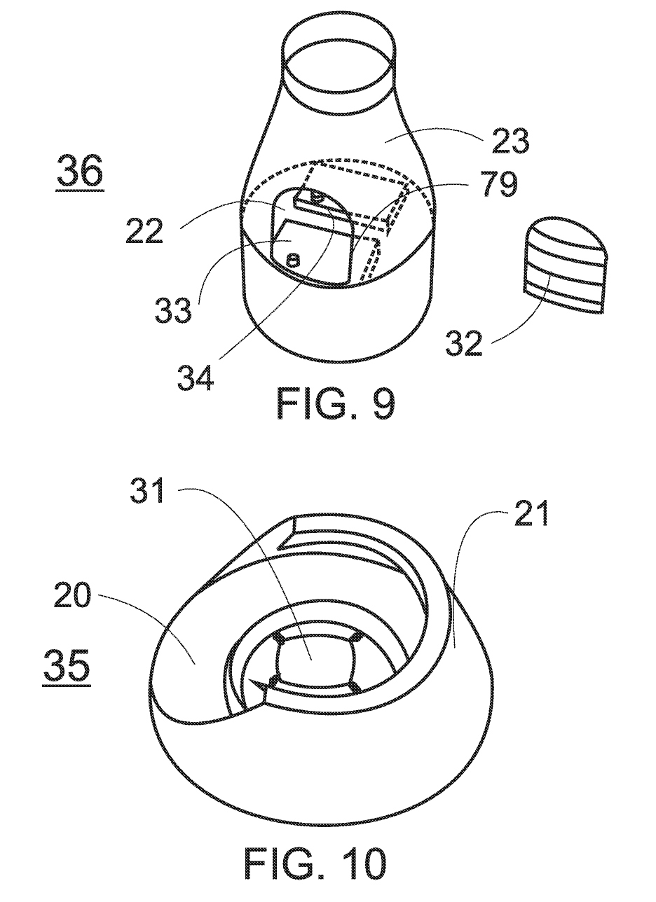

Referring to FIG. 9, a perspective view of the pylon 36 is shown showing the position of the battery deck 22 after assembly. The battery deck 22 is attached inside the pylon 36 such as via aluminum pop rivets or other techniques common to the industry, in such a position that the primary power sources 33 and 34 provide stability to the portable traffic signal 15. A means of providing access to the primary power sources 33 and 34 is provided through aperture 79. An access panel 32 is provided to cover the aperture 79 in the pylon shell 23 of the pylon 36 in accordance with the present invention. The access panel 32 as shown is removable but can also be attached to the pylon shell 23 with hinges and latching mechanisms common to the industry to form an access door. As mentioned above the pylon shell 23 is designed with an aperture 79 covered by the access panel 32 in the lower portion of the pylon shell 23 that is used to facilitate installation and service of the primary power sources 33 and 34. The primary power sources 33 and 34 are preferably 12 V sealed lead acid batteries, however a person of ordinary skill in the art can readily adapt other power sources such as fuel cells, generators and the like for use. The access panel 32 also is used to facilitate connection of applicable power cables during the assembly of the portable traffic signal 15.

FIG. 10 shows a sectional view of the base 35 in accordance with the present invention. As shown, one or more sand bag(s) 31 can be placed within the space formed between the base plate 20 and the base shell 21 of the base assembly 35 to provide additional stability to the portable traffic signal 15.

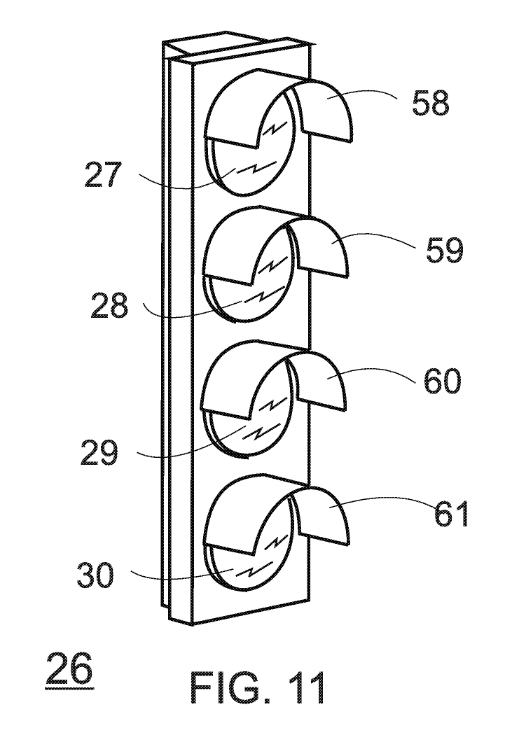

Referring to FIG. 11, a perspective view of an industry standard four section signal housing 26 is shown in accordance with the present invention. Each signal housing 26 includes tunnel visors 58, 59, 60, and 61 which shield a red LED signal lamp 27, a yellow LED signal lamp 28, a green LED signal lamp 29, and when required at the particular intersection an arrow LED signal lamp 30, respectively. Each LED signal lamp 27, 28, 29, and 30 are industry standard 12-inch diameter lamps. Four signal-housing assemblies are used in the portable traffic signal 15 of FIG. 1 in accordance with the present invention, one mounted on each face of signal head shell 24 as previously discussed in FIG. 7.

Alternate signal housing assembly configurations are possible. One or more LED lamps can be deleted or added to each or any face of the signal head shell 24. The LED lamps can be arranged in a parallel configuration of two columns on each face of the signal head shell 24 instead of in a single column as described by example above. LED lamps that convey signals other than the standard red, yellow, green, or arrow indications can also be implemented as required.

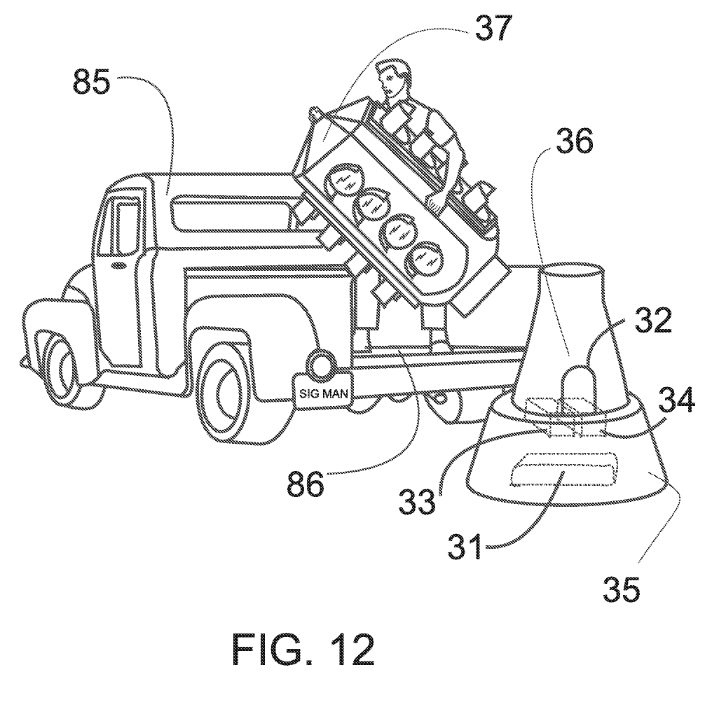

Referring to FIG. 12, one method of deployment of the portable traffic signal 15 is shown in accordance with the present invention. As described above, the portable traffic signal 15 is designed to be easily assembled on location by one person working from the bed of a pick-up truck or other service platform without the use of additional fasteners. The base 35 is positioned in the intersection behind the truck 85. Sand bag(s) 31 are added for stability when needed as described above in FIG. 10. Then the pylon 36 is placed inside the base 35. Next, while standing in the truck bed 86 or other service platform the signal head 37 is positioned over the pylon 36. Finally, power source 33 and power source 34 are installed in the pylon 36, and all necessary wiring is connected, and the access panel 32 is closed.

The deployment method described is the preferred method for small municipalities. For quicker more efficient deployment the portable traffic signal 15 can be pre-assembled in its entirety with the base assembly 35, pylon assembly 36 and signal head assembly 37 fastened together appropriately into a composite unit and a lifting feature added to the portable traffic signal 15 such that the entire unit could be lowered into position by a crane or lift gate on a service vehicle. Multiple signals could be deployed from one vehicle or trailer.

Referring to FIG. 13, a schematic block diagram of the controller and conflict monitor 71 are shown in accordance with the present invention. A 12 Vdc low power controller and conflict monitor 71, hereinafter referred to as the controller 71 is mounted behind one of the LED lamps, such as arrow lamp 30 as shown and described above in FIG. 8, preferably in the bottom of the signal housing 26 designated as the primary signal housing.

The 12 Vdc low power controller and conflict monitor 71, as represented by the blocks enclosed by the dotted line in FIG. 13, is composed of the following functional blocks; phase control module 40, timing module 41, lamp drivers 42, mode select 43, conflict monitor 44, conflict monitor timing module 45, impact sensor 46, battery monitor 47, microprocessor 49, GPRS modem 48, blue tooth port 50, real time clock 70, memory 72, GPS receiver 78, remote control receiver 75, and RF receiver transmitter 74. The primary power source 33 and 34, conflict monitor power 57, ambient light sensor 69, the blue strobe 52, the shell lighting LEDs 51, 53, and 54, video camera(s) 73, various sensors 77, handheld remote control 76 and LED signal lamps 27, 28, 29, 30 are located elsewhere. Each circuit is designed using standard off-the-shelf building blocks common to the electronics industry.

The phase control module 40 is hardware configured to provide six standard signal plans which produce the lamp driver signals that control when the various LED signal lamps (27, 28, 29 30) on the four signal faces are lit. The lamp signals from phase control module 40 control lamp drivers 42 which in turn cause the LED signal lamps (27, 28, 29, and 30) to light. Phase control module 40 communicates with timing module 41, which provides a system clock function and other hardware timing signals as needed to implement proper lamp signal sequence and durations. Phase control module 40 also interfaces with the mode select module 43 which provides a simple user interface function and signals to tell the phase control module 40 which of the available signal plans should be displayed. Phase control module 40 is capable of functioning independently of microprocessor 49.

The phase control module 40 provides a means to minimize power consumption, such as shutting down inactive portions of the phase control module 40, conflict monitor 44, and mode select module 43 controlled by timing module 41 using industry standard techniques. Further the phase control module 40 and conflict monitor 44 provide a means to flash the lamps 180 degrees out of phase when in the flashing mode reducing peak drain on batteries by 50% and extending usable battery life.

The ambient light sensor 69 provides a signal to the phase control module 40 that then adjusts the drive signal to the LED signal lamps (27, 28, 29 30) to maintain apparent brightness and conserve power. In one implementation of the present invention, the signal from the ambient light sensor 69 is used to turn the blue strobe 52 and shell lighting LEDs 51, 53, and 54 on at dusk. The blue strobe 52 and shell lighting LEDs 51, 53, and 54 are then turned off after a period of time via a timing signal from the timing module 41 to conserve power.

The conflict monitor 44 is a self contained module that is capable of independently flashing the red signal lamps 27 in the event of a system failure such as when green signals are illuminated for conflicting lanes of traffic. An independent conflict monitor timing module 45 provides timing for the conflict monitor 44. The impact sensor and tilt sensor 46 provide a means to detect an impact to the signal and a means to detect a knock over of the portable traffic signal 15. Impact sensor and tilt sensor 46 communicates with the conflict monitor 44 and provides an electrical signal(s) to indicate when the portable traffic signal 15 has been impacted or knocked over. The battery monitor 47 provides a means to sense primary and secondary power sources condition. Electrical signals are provided to the conflict monitor 44 when primary power sources 33 and 34 voltages are low, and/or depleted and when the conflict monitor power source 57 is depleted. Battery monitor 47 also provide a means to switch from primary power 33 and 34 to the conflict monitor power source 57 when the primary power sources 33 and 34 become depleted. In addition battery monitor 47 provides a means to switch signal lamp control to the conflict monitor 44 when the primary power sources 33 and 34 are depleted.

When a fault is detected the conflict monitor 44 will disable the phase control module 40. The conflict monitor 44 will set internal status indicators and/or cause the microprocessor 49 to initiate a service call via the GPRS modem 48, blue tooth port 50, or RF receiver transmitter 74.

Microprocessor 49 enables the signal to further conserve power and enables the signal to further interact with the environment. The preferred implementation for control of the blue strobe 52 and shell lighting LEDs 51, 53, and 54 is to use the real time clock 70 and the microprocessor module 49 to control the blue strobe 52 and shell lighting LEDs 51, 53, and 54. This approach allows the blue strobe 52 to be illuminated at peak traffic time's only, further conserving system power.

The real time clock 70 also communicates with the phase control module 40 through the microprocessor 49 and can cause the signal lamps (27, 28, 29, 30) to switch from normal sequence operation mode to flashing red mode or flashing red/yellow mode in off peak traffic hours (as an example, between 1 AM and 5 AM) to further conserve system power. The microprocessor has the ability to read and report manual mode switch settings and override the manual setting if desired by a remote operator. This microprocessor override feature can be manually locked out at the signal via the mode control module 43.

Microprocessor module 49 interfaces with memory module 72 in a standard method common to the art. Memory module 72 is of the non-volatile technologies such that battery depletion will not cause the loss of stored data and programming. Microprocessor module 49 is provided with a means to interface with an operator or service personnel through blue tooth port 50, GPRS modem 48, and RF receiver transmitter 74 to input system parameters, mode commands, or read out system status, service requests, diagnostic information, means to report a unique identification number, unit location etc.

The GPS receiver 78 provides a means to implement GPS functionality for signal location identification. The GPRS modem 48, blue tooth port 50, and RF receiver transmitter 74 then provide a means to report position information. The GPRS modem 48, blue tooth port 50 and RF receiver transmitter 74 also provide a means to control the signal remotely. A means to collect and communicate telemetry data from sensors as may be connected to microprocessor 49 through the GPRS modem 48, blue tooth port 50 and RF receiver transmitter 74 to an operator or control center. The RF receiver transmitter provides a means to network between signals and between signals and command centers. The RF signals from the receiver transmitter 74 are encoded using an industry standard format to provide users with a secure communications link.

Although GPRS is the preferred cellular protocol one of ordinary skill in the art will realize that other cellular protocols will work effectively for a communication link. Alternative protocols that come to mind include but are not limited to CDMA, TDMA and GSM.

Video camera(s) 73 communicate with the microprocessor 49 through an industry standard interface. The video camera(s) 73 interface with the microprocessor 49 and provide a video feed or still photos that can then be transmitted upon request by a remote operator over one of the communication links

RF receiver transmitter 74 communicates with the microprocessor 49 through an industry standard interface. The RF receiver transmitter 74 when interfaced with the microprocessor 49 and associated software provides the capability to communicate between signals and between one or more control units. A signal can transmit its own telemetry information, receive commands over the RF link, or relay telemetry and commands between another signal and the control units.

The remote control receiver 75 communicates with the mode select module 43 and provides a means to remotely set signal function through hand held remote control 76.

One embodiment of the signal is designed for Home Land Security use and various sensors 77 is included in FIG. 13 and connected to the microprocessor through industry standard parallel and serial port connections for potential defense applications. Possible examples of various sensors 77 could be, but not limited to, air quality sensors, biohazard sensors, radiation sensors, etc. The various sensors 77 feature could also be used by law enforcement and the DOT to monitor traffic speed, take traffic counts and the like. The various sensors 77 could also be used when properly provisioned to implement a dynamic controller that would respond to real time traffic conditions.

During normal operation of portable traffic signal 15, the portable traffic signal 15 would be placed on the road way as described in FIG. 12 above. The operator then manually accesses the control board 71 to set the normal operation mode and start operation of the signal. Alternatively, the operator uses the hand held remote control 76 to set the normal operation mode and start the signal. Operation can also be initiated via the blue tooth port 50, RF receiver transmitter 74, or the GPRS modem 48. The portable traffic signal 15 will continue to operate with the selected mode and options until the power source 33 and power source 34 are depleted or another outside event occurs.

The conflict monitor 44 continuously monitors the output of the phase control module 40 looking at green, yellow, and green/yellow arrow lamp signals searching for faults that cause right-of-way permissions in opposing directions or multiple lamps lit on the same face. When a malfunction is detected that could cause an accident the phase control module 40 is shut down and control of the red lamps 27 is taken over by the conflict monitor 44. The conflict monitor 44 will flash the red lamps 27 until the conflict monitor power 57 is depleted or until the system is manually reset.

The conflict monitor 44 will also switch to flashing red mode when the power source 33 and power source 34 are low to conserve power in the signal. Eventually, when the power source 33 and power source 34 become depleted the conflict monitor will switch over to the conflict monitor power source 57 and continue the flashing red signal. At some point, the conflict monitor power source 57 will become depleted and the conflict monitor will shut down the red lamps 27.

However the conflict monitor 44, microprocessor 49, GPRS modem 48 and blue tooth ports 50 will continue to operate for some time. After primary power and conflict monitor power are depleted below levels necessary to power the signal lamps, the conflict monitor 44 and microprocessor 49 and associated circuits are still able to function. This means that the signal can still be accessed via the GPRS modem 48 even when it appears to be dead. This feature is convenient when unauthorized persons move the signal since it will still be able to report its position via the modem link. In addition, service personnel can interrogate the signal through the blue tooth port and extract status and diagnostic info even when the batteries are below the level required to power the LED lamps.

The conflict monitor 44 is capable of sensing a vehicle impact with the signal through impact sensor 46. When an impact is detected, the conflict monitor 44 will set internal indicators and cause a service call to be initiated via the GPRS modem 48, blue tooth port 50, and/or RF receiver transmitter 74. Service requests are initiated by the conflict monitor when the power source 33 and power source 34 are low or depleted and when the conflict monitor power source 57 is depleted.

The design of the portable traffic signal 15 in accordance with the present invention is novel in its approach and due to its light weight construction and large high visibility profile, represents less of a risk to motorists. As such, it is a much safer on-the-road solution. In one embodiment of the present invention, the portable traffic signal 15 is made from three sections of lightweight fiberglass shell that can be deployed from the back of a pick-up truck and assembled on site. In another embodiment of the present invention, the portable traffic signal 15 can be deployed fully assembled from the back of a truck with suitable lifting mechanisms. The fiberglass shell is large enough to be easily visible, yet is lightweight and poses little risk to motorists in the event of a collision with the signal. This signal overcomes both the visibility and crash risk issues of other on-the-road portable signals on the market today.

While the present invention has been described in connection with a preferred embodiment, it is not intended to limit the scope of the present invention to the particular form set forth, but on the contrary, it is intended to cover such alternatives, modifications, and equivalents as may be included within the spirit and scope of the present invention as defined by the appended claims.

What I claim is:

1. A portable traffic signal for controlling traffic through an intersection, comprising:
a base for surrounding and capturing a pylon;
said pylon, having a lower portion mechanically coupled to said base and an upper portion mechanically coupled to a signal head; and
a primary power source, positioned within said lower portion pylon, for providing power to said signal head.

2. The portable traffic signal according to claim 1, wherein said primary power source comprises at least one battery that provides power to said signal head and stabilizes said signal head.

3. The portable traffic signal according to claim 1 wherein said base, said pylon, and said signal head are manually assembled at the intersection.

4. The portable traffic signal according to claim 3, wherein said base, said pylon, and said signal head are manually assembled at the intersection without additional mechanical fasteners.

5. The portable traffic signal according to claim 1, wherein said base has provision for holding one or more sandbags for stabilizing the traffic control signal.

6. The portable traffic signal according to claim 1 wherein
said base comprises a base plate and a base shell, and wherein said base plate locates and centers said pylon in said base.

7. The portable traffic signal according to claim 1 wherein said pylon comprises a battery deck and a pylon shell, and wherein said battery deck supports said power source in said pylon.

8. The portable traffic signal according to claim 7 wherein said battery deck and said pylon shell utilize LED lighting arranged internally to illuminate said pylon and said base.

9. The portable traffic signal according to claim 1 wherein said signal head comprises a signal head shell and three or more signal housings.

10. The portable traffic signal according to claim 9 wherein each of said three or more signal housings holds three or more signal lamps.

11. The portable traffic signal according to claim 1 wherein said base, said pylon, and said signal head are fabricated from a plastic material selected from a group of plastic materials consisting of a composite glass and polyester resin, graphite and polyester resin, UV protected polycarbonate, polystyrene, and high density polypropylene.

12. The portable traffic signal according to claim 11 wherein said base, said pylon and said signal head are fabricated from said plastic materials using a fabrication process selected from a group of fabrication processes consisting of molding, thermoforming, vacuum forming, pressure forming, twin sheet forming, and blow molding.

13. The portable traffic signal according to claim 11 wherein said base, said pylon and said signal head are manufactured from translucent material.

14. The portable traffic signal according to claim 11 wherein said base, said pylon and said signal head are fabricated from materials impregnated with a phosphorescent material, and wherein said base, said pylon and said signal head are coated either internally or externally with said phosphorescent material.

15. The portable traffic signal according to claim 1 further comprising:
a signal controller and a conflict monitor;
a first receiver to communicate with said signal controller;
a second receiver to collect and communicate telemetry data; and
a transmitter to network between portable traffic signals and a command center.

16. The portable traffic signal according to claim 15 further comprising;
a secondary power source for said conflict monitor;
a battery monitor for detecting a condition of said primary and secondary power sources; and
an impact sensor for detecting an impact to the portable traffic signal, said impact sensor further for detecting a knock over of the portable traffic signal,
said transmitter transmitting a status of said primary and secondary power sources and a condition of the portable traffic signal to said command center,
said battery monitor further switching power from said primary power source to said secondary power source when said primary power source is depleted.

17. The portable traffic signal according to claim 15 further comprising:
a power controller to minimize power consumption; and
a phase controller to flash the signal lamps 180 degrees out of phase when in a flashing mode, said power controller further shutting down inactive portions of said signal controller and said conflict monitor.

18. The portable traffic signal according to claim 15 further comprising
a GPRS modem providing a means to call for service when said primary power source is depleted, and when the portable traffic signal has been impacted,
said GPRS modem further providing the call for service when a fault or conflict is detected, the call for service including a unique identification number identifying the portable traffic signal.

19. The portable traffic signal according to claim 18 further comprising a GPS receiver for receiving GPS location information, wherein said GPRS modem generates a report of the portable traffic signal location.

20. The portable traffic signal according to claim 15 further comprising a Blue Tooth interface for enabling remote operator access to said controller via a blue tooth link.
